(19) United States
(12) Patent Application Publication
(10) Pub. No.: US 2018/0237054 A1
(43) Pub. Date: Aug. 23, 2018

(54) CLAMPING DEVICE OF AN ADJUSTABLE STEERING COLUMN FOR MOTOR VEHICLES

(71) Applicants: THYSSENKRUPP PRESTA AG, Eschen (LI); thyssenkrupp AG, Essen (DE)

(72) Inventors: Hieronymus SCHNITZER, Gamprin (LI); Ciprian PALTINISANU, Feldkirch (AT)

(73) Assignees: THYSSENKRUPP PRESTA AG, Eschen (LI); thyssenkrupp AG, Essen (DE)

(21) Appl. No.: 15/752,310

(22) PCT Filed: Aug. 4, 2016
(86) PCT No.: PCT/EP2016/068645

§ 371 Date: Feb. 13, 2018

(30) Foreign Application Priority Data
Aug. 13, 2015 (DE) 10 2015 215 433.5

(51) Int. Cl. B62D 1/184; B62D 1/187

(52) U.S. Cl. CPC B62D 1/184; B62D 1/187

(57) ABSTRACT

A clamping device of an adjustable steering column for motor vehicles may include a carrier that is connected to a vehicle chassis and to two clamping jaws that encompass the steering column. An axially and/or vertically adjustable casing tube of the steering column may be clamped between the two clamping jaws, which casing tube receives a steering spindle. The clamping device may also include a clamping bolt that connects the two clamping jaws and interacts with a fastening device disposed on at least one of the two clamping jaws such that rotation of the clamping bolt in a fastening direction causes the two clamping jaws to clamp the casing tube and such that rotation of the clamping bolt counter to the fastening direction causes the clamping jaws to release the casing tube for the steering column adjustment. An actuating lever may be welded to one end of the clamping bolt.

The invention relates to a clamping device of an adjustable steering column for motor vehicles, in which clamping device a carrier which is connected fixedly to the vehicle chassis is connected to two clamping jaws which encompass the steering column and between which an axially and/or vertically adjustable casing tube of the steering column can be clamped fixedly, which casing tube receives a steering spindle, having a clamping bolt which connects the two clamping jaws and interacts with a fastening device which is arranged on at least one of the two clamping jaws, in such a way that, in the case of a rotation of the clamping bolt in the fastening direction about the bolt axis, the two clamping jaws clamp in the casing tube fixedly, and that, in the case of a rotation of the clamping bolt counter to the fastening direction, the clamping jaws release the casing tube for the steering column adjustment, and having an actuating lever which is fastened to one end of the clamping bolt for rotating the clamping bolt.

A clamping device of this type is known, for example, from WO 2009 141 045 A1. The known clamping device has a tensioning part in the form of a cam plate, which tensioning part is arranged on a tensioning bolt. The cam has a shaped contour on one side. The actuating lever has a depression with a corresponding shaped contour with respect to the cam plate, as a result of which a positively locking connection of the two components is made possible.

A disadvantage of said solution is that the structural unit comprising the lever and the tensioning bolt requires a considerable amount of installation space, and the rotational position of the lever with respect to the tensioning part is fixed from the outset, and possible tolerances of the components can lead to changing rotational positions in the open and closed position of the tensioning device.

DE 10 2010 000 504 B3 discloses a clamping device, in which the tensioning bolt is connected to the actuating lever in such a way that the tensioning bolt and/or a cam part have/has a toothing portion, onto which the plastic lever is pressed in a joining region, with the result that the toothing sections can dig into the joining region.

A disadvantage of said solution is that a toothing section is required for connecting the clamping bolt to the actuating lever, which toothing section requires installation space and an additional work step during the manufacture and causes costs. A further disadvantage is that the disclosed bolt is plugged through the through bore of the lever, and a component projection is therefore produced.

It is an object of the invention to provide an improved connection between the clamping bolt and the actuating lever, which improved connection requires a smaller amount of installation space. Furthermore, a simple configuration and assembly are to be made possible.

The invention achieves the object by virtue of the fact that the actuating lever is welded to the clamping bolt. A component projection can advantageously be avoided as a result. In addition, the measure according to the invention can be realized inexpensively. Furthermore, the welded connection ensures that very high torques can be transmitted from the actuating lever to the clamping bolt. One advantageous refinement of the invention provides that that end of the clamping bolt which is to be welded to the actuating lever is configured as a disk-shaped bolt head which is welded to the actuating lever. On its side which faces the actuating lever, the disk-shaped bolt head has a greater surface area to be welded to the actuating lever than a clamping bolt without a bolt head of this type would have. As a result, the welded point can transmit greater torques than would be the case without the widened bolt head. The connection between the actuating lever and the clamping bolt therefore becomes even more stable.

The invention can be improved further by way of the measure that the actuating lever has a blind bore-like recess for receiving that end of the clamping bolt which is to be welded. This makes the receiving and centering of the disk-shaped bolt head in the material of the actuating lever possible, with the result that the actuating lever itself can be accommodated in a space-saving manner without an additional spacing from the clamping jaw which lies against it.

It is provided in one preferred embodiment of the invention that the clamping bolt is connected to the actuating lever by way of rotary friction welding. This type of welding is preferred because identical or partially also different metallic materials can be connected to one another in this way. Furthermore, the friction welding makes it possible that an integrally joined connection takes place over the entire component cross section which lies against one another, and not only at its periphery. A very much stronger connection between the components is therefore obtained by way of this type of welded connection, which connection permits a higher transmission of torque. Finally, the parameters of the friction welding process, such as rotational speed, pressure, torque and component projection, can be monitored and stipulated simply, with the result that the desired result can be achieved with great certainty and the quality is ensured.

One exemplary embodiment of the invention will be described in greater detail in the following text using the drawings, in which, in detail:

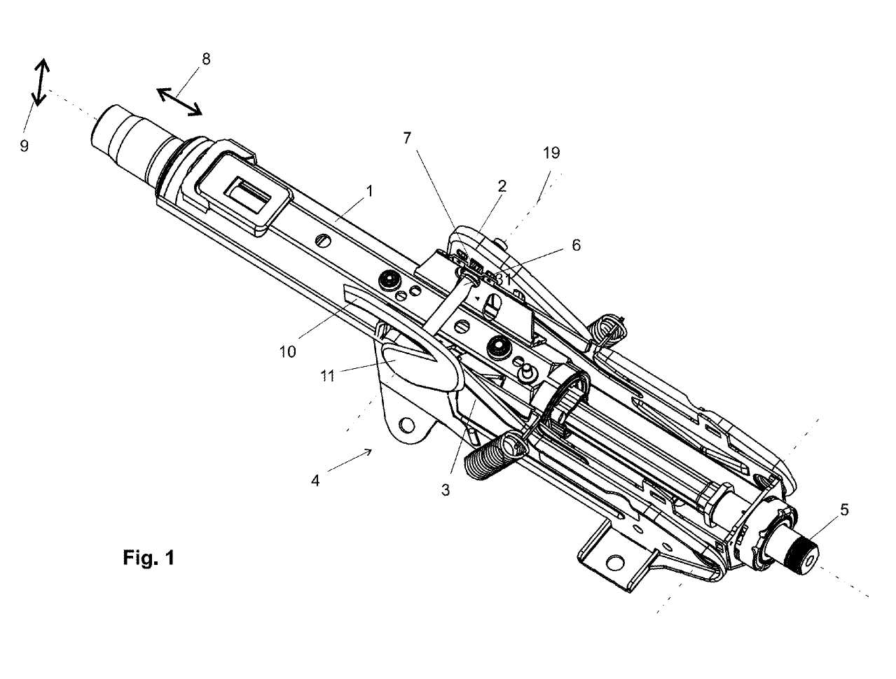

FIG. 1 shows an adjustable steering column for motor vehicles having a clamping device according to the invention, in a perspective illustration,

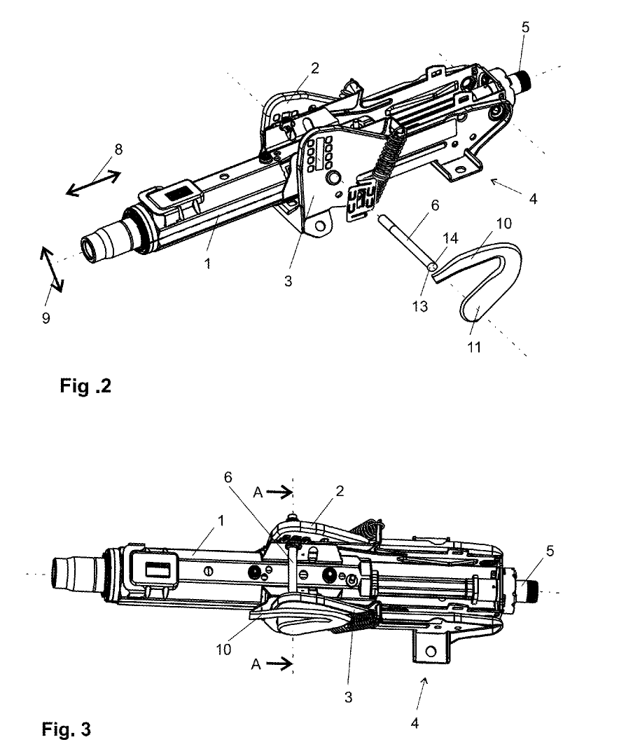

FIG. 2 shows an adjustable steering column for motor vehicles as in FIG. 1, with a dismantled clamping bolt and actuating lever,

FIG. 3 shows a somewhat different perspective illustration of the steering column from FIG. 2, with a mounted clamping bolt and actuating lever,

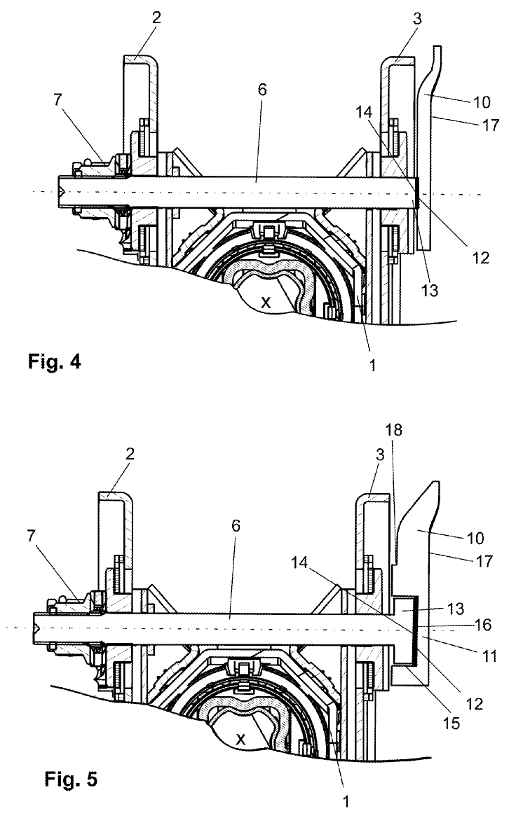

FIG. 4 shows a partial view of a cross section according to line A-A from FIG. 3, and

FIG. 5 shows a further partial view of a cross section according to line A-A from FIG. 3.

The steering column for motor vehicles which is shown in FIG. 1 has a casing tube 1 which can be clamped fixedly between two clamping jaws 2, 3. The clamping jaws 2, 3 are for their part fastened to a carrier 4 of the steering column, which carrier 4 connects the steering column fixedly to the vehicle chassis. A steering spindle 5 is arranged rotatably in the interior of the casing tube 1, which steering spindle 5 for its part consists of at least two parts which can be displaced telescopically inside one another. Furthermore, the two clamping jaws 2, 3 are connected to one another by way of a clamping bolt 6 which interacts with a fastening device 7 in such a way that, in the case of a rotation of the clamping bolt 6, the two clamping jaws 2, 3 are moved toward one another until they clamp in the casing tube 1 of the steering column fixedly between them. In the simplest case, the fastening device 7 can be a nut which is screwed onto an external thread of the clamping bolt 6. Fastening devices with ball ramps or pin mechanisms are preferably used, however.

In the case of a rotation of the clamping bolt 6 counter to the fastening direction in the opening direction, the fastening device 7 will therefore release the casing tube 1, with the result that the steering column can be adjusted both in the axial direction 8 and in the vertical direction 9. After the adjustable steering column is set into the desired position, the fastening device 7 is fastened again and locked by way of rotation of the clamping bolt 6 in the fastening direction, with the result that the casing tube 1 can no longer be moved.

An actuating lever 10 is provided for rotating the clamping bolt 6, the end 11 of which actuating lever 10 is connected fixedly to the clamping bolt 6.

According to one advantageous embodiment of the invention which is shown in FIG. 4, the actuating lever 10 is of planar configuration on its side 18 which faces the steering column 1. At the end 13 which is to be welded, the end face 14 of the clamping bolt 6 is connected to the actuating lever 10 by way of rotary friction welding, the entire end face 14 of the bolt head 13 being welded over the full area on a side 18 of the actuating lever 10, which side 18 faces the steering column 1.

An alternative embodiment, which can be seen most clearly in FIG. 5, is that the actuating lever 10 is welded to the clamping bolt 6 at the welded point 12. For this purpose, the clamping bolt 6 is provided with a bolt head 13 at its end 13 which is to be welded, the entire end face 14 of which bolt head 13 is welded to the actuating lever 10. The disk-shaped bolt head 13 is formed in one piece during the manufacture of the clamping bolt 6. The end 11 of the actuating lever 10 is provided with a blind bore-like recess 15 which receives the disk-shaped bolt head 13. The disk-shaped bolt head 13 of the clamping bolt 6 is connected to the actuating lever 10 by way of rotary friction welding, the entire end face 14 of the bolt head 13 being welded over the full area to the entire base face 16 of the recess 15. As an alternative, at its end 13 which is to be welded, the clamping bolt 6 can be welded to the entire end face 14 in a recess 15 of the actuating lever 10.

The welding according to the invention of the bolt head 13 to the actuating lever 10 results in an extremely fixed and durable connection of the two components, with the result that very high torques can be transmitted to the clamping bolt 6 by way of the actuating lever 10, without the welded connection being released. Further advantages of the invention consist in that no material projections at all remain on that side 17 of the actuating lever 10 which faces away from the steering column, and that the actuating lever 6 is arranged with its side 18 which faces the steering column without a substantial spacing from the steering column and therefore in a space-saving manner. Finally, the parameters of the friction welding method can be kept under control reliably even in the case of automatic manufacture of the steering column, with the result that high quality is ensured with low manufacturing costs.

### LIST OF DESIGNATIONS

1 Casing tube
2 Clamping jaws
3 Clamping jaws
4 Carrier
5 Steering spindle
6 Clamping bolt
7 Fastening device
8 Axial direction
9 Vertical direction
10 Actuating lever
11 End
12 Welded point
13 Bolt head/end
14 End face
15 Recess
16 Base face
17 Side
18 Side
19 Bolt axis

1.-4. (canceled)

5. A clamping device of an adjustable steering column for motor vehicles, the clamping device comprising:
a carrier that is connected to a vehicle chassis;
two clamping jaws that are connected to the carrier, the two clamping jaws encompassing the adjustable steering column;
a casing tube that receives a steering spindle and is at least one of vertically adjustable or axially adjustable, the casing tube being configured to be clamped between the two clamping jaws;
a clamping bolt that connects the two clamping jaws and interacts with a fastening device disposed on at least one of the two clamping jaws such that the two clamping jaws clamp the casing tube upon a rotation of the clamping bolt in a fastening direction about a bolt axis and such that the two clamping jaws release the casing tube upon a rotation of the clamping bolt counter to the fastening direction; and
an actuating lever that is welded to an end of the clamping bolt for rotating the clamping bolt.

6. The clamping device of claim 5 wherein the end of the clamping bolt welded to the actuating lever is a plate-shaped bolt head.

7. The clamping device of claim 6 wherein the actuating lever has a blind bore-like recess that receives the end of the clamping bolt that is welded to the actuating lever.

8. The clamping device of claim 5 wherein the actuating lever has a blind bore-like recess that receives the end of the clamping bolt that is welded to the actuating lever.

9. The clamping device of claim 5 wherein the clamping bolt is connected to the actuating lever by way of a rotary friction weld.

10. The clamping device of claim 5 wherein the actuating lever is planar.

11. The clamping device of claim 5 wherein an end face of the end of the clamping bolt is welded over a full area to a base face of a recess of the actuating lever.

12. The clamping device of claim 5 wherein a surface of the actuating lever that faces away from the adjustable steering column is planar.

13. A clamping device of an adjustable steering column comprising:
two clamping jaws that receive a portion of the adjustable steering column;
a casing tube that is at least one of vertically adjustable or axially adjustable, wherein the casing tube is selectively clamped between the two clamping jaws;
a clamping bolt that connects the two clamping jaws and engages with a fastening device disposed on at least one of the two clamping jaws such that the two clamping jaws clamp the casing tube upon a rotation of the clamping bolt in a fastening direction and such that the two clamping jaws release the casing tube upon a rotation of the clamping bolt counter to the fastening direction; and
an actuating lever that is welded to an end of the clamping bolt.

14. The clamping device of claim 13 wherein the end of the clamping bolt welded to the actuating lever is a plate-shaped bolt head.

15. The clamping device of claim 14 wherein the actuating lever has a blind bore-like recess that receives the end of the clamping bolt that is welded to the actuating lever.

16. The clamping device of claim 13 wherein the actuating lever has a blind bore-like recess that receives the end of the clamping bolt that is welded to the actuating lever.

17. The clamping device of claim 13 wherein the clamping bolt is connected to the actuating lever by way of a rotary friction weld.

18. The clamping device of claim 13 wherein the actuating lever is planar.

19. The clamping device of claim 13 wherein an end face of the end of the clamping bolt is welded over a full area to a base face of a recess of the actuating lever.

20. The clamping device of claim 13 wherein a surface of the actuating lever that faces away from the adjustable steering column is planar.
